(19) United States
(12) Patent Application Publication
(10) Pub. No.: US 2023/0275242 A1
(43) Pub. Date: Aug. 31, 2023

(54) SOLID OXIDE FUEL CELL DEVICE AND FUEL CELL VEHICLE

(71) Applicants: AUDI AG, Ingolstadt (DE); VOLKSWAGEN AG, Wolfsburg (DE)

(72) Inventors: Christian LUCAS, Braunschweig (DE); Harald HEINRICH, Braunschweig (DE)

(21) Appl. No.: 18/005,582

(22) PCT Filed: Sep. 13, 2021
(86) PCT No.: PCT/EP2021/075032

§ 371 Date: Jan. 13, 2023

(30) Foreign Application Priority Data
Sep. 16, 2020 (DE) 10 2020 124 077.5

(51) Int. Cl. H01M 8/04014; H01M 8/04089

(52) U.S. Cl. CPC H01M 8/04014; H01M 8/04097; H01M 2250/20

(57) ABSTRACT

A solid oxide fuel cell device comprises a fuel cell stack, with a fuel tank which is connected to the fuel cell stack at the anode side by an anode supply line, being associated with a jet pump into which an anode recirculation line empties, having a compressor which is connected to the fuel cell stack at the cathode side by a cathode supply line, being associated with an air preheater, through which a cathode exhaust gas line is led for the transfer of heat from the cathode exhaust gas. In the anode supply line, upstream from a driving nozzle of the jet pump, there is arranged a heat exchanger, which is integrated with the jet pump, to which heat from the cathode exhaust gas can be supplied by an exchanger line. A fuel cell vehicle having a solid oxide fuel cell device is also provided.

### BACKGROUND

### Technical Field

Embodiments of the invention relate to a solid oxide fuel cell device having a fuel cell stack, with a fuel tank which is connected to the fuel cell stack at the anode side by an anode supply line. Embodiments of the invention furthermore relate to a fuel cell vehicle.

### Description of the Related Art

Fuel cells serve for providing electric energy in a chemical reaction between a hydrogen-containing fuel and an oxygen-containing oxidizing agent, generally air. In a solid oxide fuel cell (SOFC) there is an electrolyte layer of a solid material, giving the cell its name, such as ceramic yttrium-doped zirconium dioxide, which is capable of conducting oxygen atoms, while electrons are not conducted. The electrolyte layer is contained between two electrode layers, namely, the cathode layer, to which air is supplied, and the anode layer, which is supplied with the fuel, which can be formed by H₂, CO, CH₄, C₃H₈ or similar hydrocarbons. If air is led through the cathode layer to the electrolyte layer, the oxygen takes up two electrons and the resulting oxygen ions O²⁻ move through the electrolyte layer to the anode layer, where the oxygen ions react with the fuel to form water and CO₂. At the cathode side, the following reaction occurs: ½ O₂+2e⁻→2O²⁻ (reduction/electron uptake). At the anode, the following reactions occur: H₂+O²⁻→H₂O+2e⁻ and CO+O²⁻→CO₂+2e⁻ (oxidation/electron surrender).

The fuel and also the oxidization agent are supplied to the solid oxide fuel cells in above the stoichiometric ratio, in order to maximize their efficiency. Fuel not reacted at the solid oxide fuel cells is recirculated in an anode circuit to economize on resources, i.e., it is supplied to the fuel cells once more. A suction jet pump with the fuel as driving medium is used to deliver the fuel, and at the same time this delivers the unreacted fuel from the anode circuit.

Solid oxide fuel cells require high temperatures over 700° C., at which they are operated, so that the use of the term high-temperature fuel cell is also customary. If methane is used as the fuel, one must be aware that this in the dry state at high temperatures and low pressures in chemical equilibrium has a tendency to decompose into carbon and hydrogen, the carbon precipitating and forming deposits constituting impurities in the system. The carbon can also settle onto the catalyst surface, resulting in diminished catalytic activity.

It must also be taken into account that the statements on carbon formation apply to the equilibrium state, the attaining of which depends on the reaction kinetics, and the dwelling in which depends on the state encouraging the decomposition. If the dwell time is reduced, the equilibrium state will not be attained. The decomposition will also end as soon as a dry state no longer occurs. Thus, if the dry methane gas is mixed with humid methane gas from the anode circuit, no more carbon is precipitated.

DE 34 27 976 A1 discloses a device for the anaerobic treatment of substrates with organic materials in order to generate biogas, namely methane. In a first reactor space there occurs a first fermentation process, namely, a hydrolysis and acid formation, while in the second reactor space the methane is formed. The first reactor space is associated with a jet pump for the hydraulic circulation of the substrate, which is supported by a thermal circulation with a heat exchanger. In WO 2009/075692 A2 there is described a reactor for the catalytic generation of hydrogen cyanide HCN, in which a preheating of the supplied gases takes place. A solid oxide fuel cell device is dealt with by the teaching of CN 208898500 U, in which it is proposed to connect a reformer to a methane supply unit, while waste heat contained in the exhaust gas of the solid oxide fuel cell device is utilized to heat the methane and the reformer.

### BRIEF SUMMARY

Some embodiments include a solid oxide fuel cell device having a fuel cell stack, with a fuel tank which is connected to the fuel cell stack at the anode side by an anode supply line, being associated with a jet pump into which an anode recirculation line empties, having a compressor which is connected to the fuel cell stack at the cathode side by a cathode supply line, being associated with an air preheater, through which a cathode exhaust gas line is led for the transfer of heat from the cathode exhaust gas, while in the anode supply line, upstream from a driving nozzle of the jet pump, there is arranged a heat exchanger, which is integrated with the jet pump, to which heat from the cathode exhaust gas can be supplied by an exchanger line.

Some embodiments provide an improved solid oxide fuel cell device in which the formation of carbon from the fuel is diminished. Some embodiments provide an improved fuel cell vehicle.

The solid oxide fuel cell device described herein may be characterized in that only a short distance remains in the fuel line for the heated fuel, especially heated methane, until the fuel cell stack is reached, so that the dwell time in the state encouraging decomposition is so short that the equilibrium condition is not attained and the carbon formation is reduced or even prevented. The heating of the methane occurs directly in front of the driving nozzle, after which the mixing with the humid recycled methane occurs. This also prevents a carbon formation.

The exchanger line may be formed as part of the cathode exhaust gas line, since in this way the heating of the methane is energy-efficient.

It is possible for the exchanger line to branch off from the cathode exhaust gas line upstream from the air preheater and to empty into the cathode exhaust gas line downstream from the air preheater. Alternatively, the design may be such that the exchanger line branches off from the cathode exhaust gas line downstream from the air preheater and once again empties into the cathode exhaust gas line downstream from the air preheater, so that the heating of the air is not affected and only unnecessary waste heat is used for the air heating.

The fuel heat exchanger may be formed by a heat transfer element situated in front of the driving nozzle, in which at least one fuel duct is formed and which stands in thermal connection with the cathode exhaust gas. Thus, a compact design is achieved, making possible a large heat transfer in a small volume. This is also favored when at least one cathode exhaust gas duct is formed in the heat transfer element or alternatively when the heat transfer element is configured with heat transfer fins and/or heatpipes, which stand in thermal connection with the cathode exhaust gas.

The above mentioned benefits and effects also hold for a fuel cell vehicle having such a solid oxide fuel cell device.

The features and combinations of features mentioned above in the description and the features and combinations of features mentioned below in the description of the figures and/or shown solely in the figures can be used not only in the particular indicated combination, but also in other combinations or standing alone. Thus, embodiments which are not shown explicitly or explained in the figures, yet which can be created and emerge from separated combinations of features from the explained embodiments should be viewed as also being disclosed and encompassed by the present disclosure.

### BRIEF DESCRIPTION OF THE SEVERAL VIEWS OF THE DRAWINGS

Further benefits, features and details will emerge from the claims, the following description of embodiments, and the drawings.

FIG. 1 shows a schematic representation of a fuel cell device having a heat exchanger for heating of the fuel upstream from a jet pump.

FIG. 2 shows a representation of an alternative embodiment corresponding to FIG. 1.

FIG. 3 shows a representation of an alternative embodiment corresponding to FIG. 1 having an alternative thermal coupling to the cathode exhaust gas path.

FIG. 4 shows a schematic representation of a jet pump with an integrated heat exchanger, through which the fuel and the cathode exhaust gas flow.

FIG. 5 shows a representation of an alternative embodiment corresponding to FIG. 4, having a heat transfer element arranged in the heat exchanger, having fuel ducts and heat transfer fins.

FIG. 6 shows a representation of a fuel cell device known from the prior art, corresponding to FIG. 1.

### DETAILED DESCRIPTION

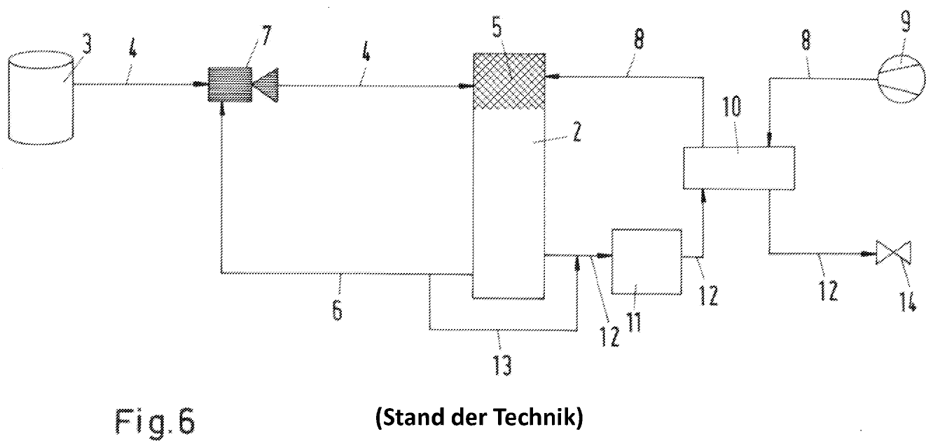

A solid oxide fuel cell device 1 known from the prior art with a fuel cell stack 2 formed from solid oxide fuel cells is shown in FIG. 6. The solid oxide fuel cell device 1 can be part of a fuel cell vehicle, for example, not otherwise shown.

Each of the fuel cells comprises an anode and a cathode as well as an ion-conductive membrane separating the anode from the cathode. The fuel, namely methane containing hydrogen, is supplied from a fuel tank 3, namely a gas pressure storage for methane, across an anode supply line 4 at first to a reformer 5 and then across anode spaces inside the fuel cell stack 2 to the anodes. Unused fuel is taken back to the anode supply line 4 across an anode recirculation line 6, making use of a jet pump 7, in which the fuel represents the driving medium. Through cathode spaces inside the fuel cell stack 2 it is possible to supply the cathodes with cathode gas, especially air containing oxygen, fed from a compressor 9, by a cathode supply line 8.

Since the solid oxide fuel cells require high temperatures over 700° C., an air preheater 10 is arranged downstream from the compressor 9 for the preheating of the air, and the cathode exhaust gas passes through it. Between the fuel cell stack 2 and the air preheater 10 there is an afterburner 11 associated with a cathode exhaust gas line 12, being supplied with unused fuel by a branching 13 off from the anode recirculation line 6 for further heating of the cathode exhaust gas. Downstream from the air preheater 10, a pressure regulating flap 14 is incorporated in the cathode exhaust gas line 12.

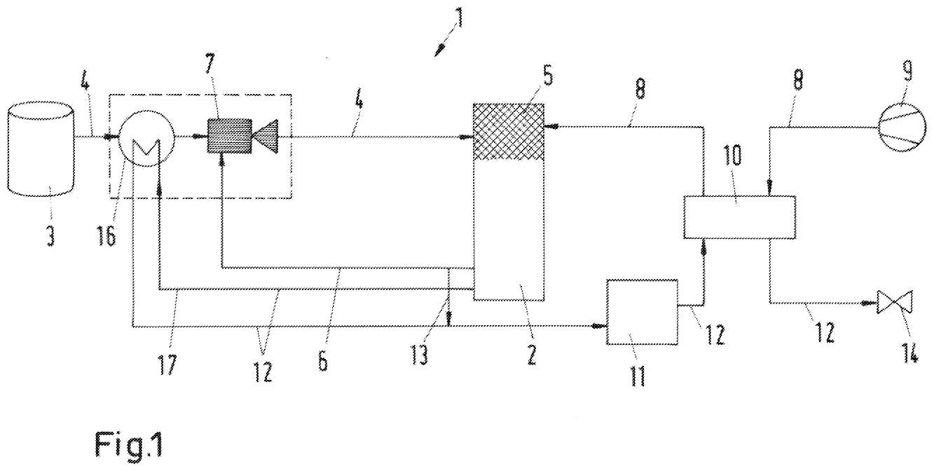

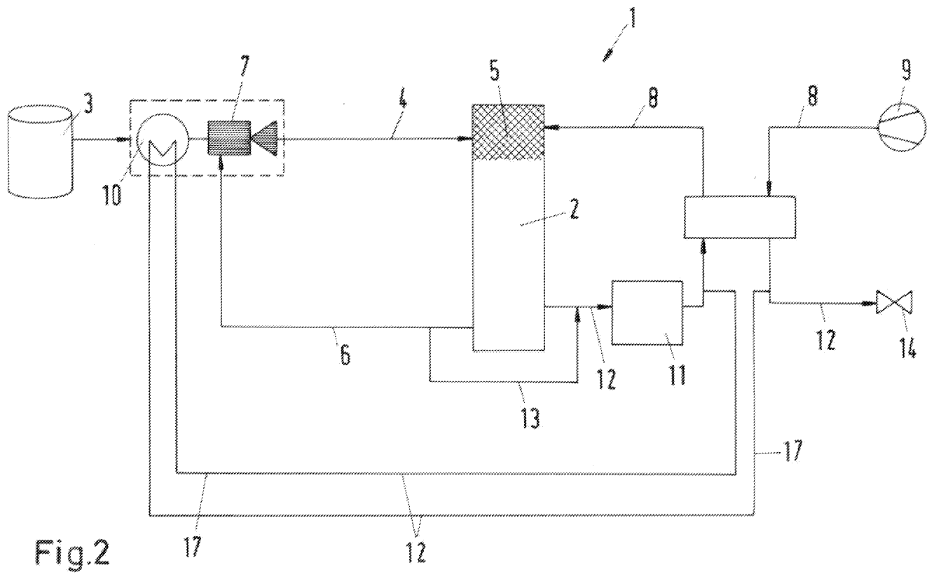

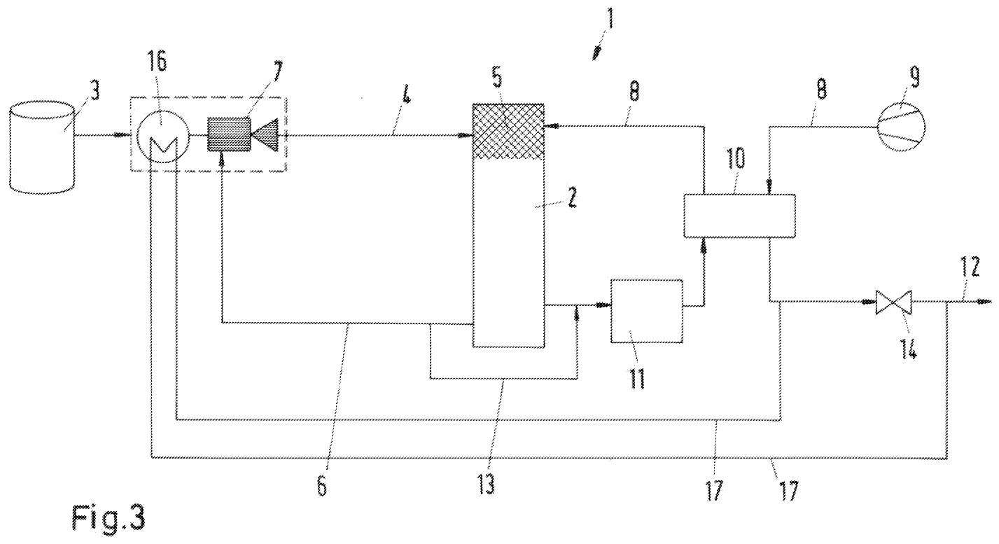

The solid oxide fuel cell device 1 is thus formed, according to FIGS. 1 to 5, with a fuel cell stack 2, with a fuel tank 3 which is connected to the fuel cell stack 2 at the anode side by an anode supply line 4 being associated with a jet pump 7 into which an anode recirculation line 6 empties, with a compressor 9 which is connected to the fuel cell stack 2 at the cathode side by a cathode supply line 8, being associated with an air preheater 10, through which a cathode exhaust gas line 12 is led for the transfer of heat from the cathode exhaust gas. In the anode supply line 4, upstream from a driving nozzle 15 of the jet pump 7, there is arranged a heat exchanger 16, which is integrated with the jet pump 7, to which heat from the cathode exhaust gas can be supplied by an exchanger line 17, the exchanger line 17 being formed as part of the cathode exhaust gas line 12. FIG. 1 shows an embodiment in which the cathode exhaust gas line 12 is led directly from the fuel cell stack 2 to the heat exchanger 16 and from here to the afterburner 11 or the air preheater 10. FIG. 2 shows an embodiment in which the cathode exhaust gas line 12 is led from the fuel cell stack 2 to the air preheater 10 and the exchanger line 17 branches off from the cathode exhaust gas line 12 upstream from the air preheater 10 and once again empties into the cathode exhaust gas line 12 downstream from the air preheater 10. In this embodiment, less heat is furnished to the air preheater 10 as compared to the embodiment of FIG. 3, in which the exchanger line 17 branches off from the cathode exhaust gas line 12 downstream from the air preheater 10 and once again empties into the cathode exhaust gas line 12 downstream from the air preheater 10.

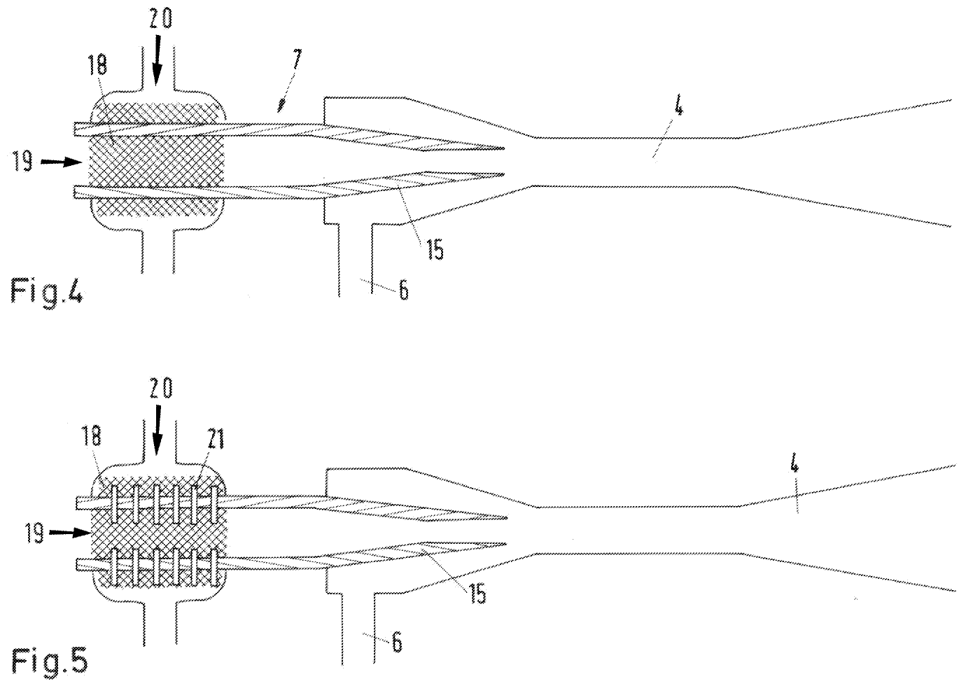

The heat exchanger 16 is formed by a heat transfer element 18 situated in front of, and therefore upstream from, the driving nozzle 15 (FIG. 4), in which at least one fuel duct 19 is formed and which stands in thermal connection with the cathode exhaust gas. In the embodiment of FIG. 4, at least one cathode exhaust gas duct 20 is formed in the heat transfer element 18.

FIG. 5 shows that the heat transfer element 18 is configured with heat transfer fins 21 and/or heatpipes, which stand in thermal connection with the cathode exhaust gas being channeled around the heat transfer element 18.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A solid oxide fuel cell device, comprising:
a fuel cell stack, with a fuel tank which is connected to the fuel cell stack at an anode side by an anode supply line, being associated with a jet pump into which an anode recirculation line empties, having a compressor which is connected to the fuel cell stack at the cathode side by a cathode supply line, being associated with an air preheater, through which a cathode exhaust gas line is led for the transfer of heat from the cathode exhaust gas,
wherein, in the anode supply line, upstream from a driving nozzle of the jet pump, there is arranged a heat exchanger, which is integrated with the jet pump, to which heat from the cathode exhaust gas can be supplied by an exchanger line.

2. The solid oxide fuel cell device according to claim 1, wherein the exchanger line is formed as part of the cathode exhaust gas line.

3. The solid oxide fuel cell device according to claim 1, wherein the exchanger line branches off from the cathode exhaust gas line upstream from the air preheater and once again empties into the cathode exhaust gas line downstream from the air preheater.

4. The solid oxide fuel cell device according to claim 1, wherein the exchanger line branches off from the cathode exhaust gas line downstream from the air preheater and once again empties into the cathode exhaust gas line downstream from the air preheater.

5. The solid oxide fuel cell device according to claim 1, wherein the heat exchanger is formed by a heat transfer element situated in front of the driving nozzle, in which at least one fuel duct is formed and which stands in thermal connection with the cathode exhaust gas.

6. The solid oxide fuel cell device according to claim 5, wherein at least one cathode exhaust gas duct is formed in the heat transfer element.

7. The solid oxide fuel cell device according to claim 5, wherein the heat transfer element is configured with heat transfer fins and/or heatpipes, which stand in thermal connection with the cathode exhaust gas.

8. A fuel cell vehicle having a solid oxide fuel cell device according to claim 1.
